(19) United States
(12) Patent Application Publication
(10) Pub. No.: US 2009/0209436 A1
(43) Pub. Date: Aug. 20, 2009

(54) HYDROGEL LABELED PRIMER EXTENSION METHOD FOR MICROARRAYS

(75) Inventors: Harry B. Larman, Falmouth, ME (US); Andrea Cuppoletti, Trento (IT)

Correspondence Address: MORRISON & FOERSTER LLP, 425 MARKET STREET, SAN FRANCISCO, CA, 94105-2482, US

(73) Assignee: TWOF, Inc., San Mateo, CA (US)

(21) Appl. No.: 12/212,600

(22) Filed: Sep. 17, 2008

Related U.S. Application Data
(60) Provisional application No. 61/049,683, filed on May 1, 2008.
(60) Provisional application No. 60/994,224, filed on Sep. 17, 2007.

(51) Int. Cl. C40B 30/04; C40B 50/14; C40B 50/18; C40B 50/06; C40B 40/04

(52) U.S. Cl. 506/9; 506/30; 506/32; 506/26; 506/15

(57) ABSTRACT

A method for fabricating hydrogel based microarrays by a nanostamping process is provided. A method of manufacturing a patterned hydrogel array is provided comprising the steps of contacting a patterned substrate with a hydrogel substrate to form a substrate complex, wherein the patterned substrate comprises a surface, a first polymer attached to the surface, and a second polymer reversibly attached to the first polymer, the hydrogel substrate comprises a polymer matrix and a plurality of attachment sites along the polymer matrix capable of attaching the second polymer, binding at least one attachment site to the second polymer, disassociating the dimer; and separating the substrate complex to obtain a patterned hydrogel array having a second polymer attached to an attachment site. Methods where the second polymer is synthesized using the first polymer as template are provided. Hydrogel arrays manufactured according to the methods of the invention are provided.

### RELATED APPLICATIONS

This application claims the benefit of U.S. Provisional Application No. 60/994,224, filed Sep. 17, 2007, and U.S. Provisional Application No. 61/049,683, filed May 1, 2008, both of which are hereby incorporated by reference in their entirety.

### TECHNICAL FIELD OF THE INVENTION

The present application relates generally to polymer microarrays and methods for fabricating polymer microarrays. In particular, the application relates to hydrogel based microarrays fabricated by a nanostamping process.

### BACKGROUND OF THE INVENTION

The analysis of biospecific agents (e.g., small molecules; proteins; and ligands) that selectively interact with biomolecules, such as by catalysis, binding, proteolysis, or other biological interactions, is of particular interest in medicinal chemistry. Such an analysis can be used for diagnostic and therapeutic applications as well as for biomolecule characterization, screening for biological activity, and other functional studies.

Whole-genome expression profiling, facilitated by the development of DNA microarrays (M. Schena, D. Shalon, R. W. Davis and P. O. Brown, Science 270 (1995), pp. 467-470), represents a major advance in genome-wide functional analysis. In a single assay, the transcriptional response of each gene to a change in cellular state can be measured, whether it is disease, a process such as cell division, or a response to a chemical or genetic perturbation ( J. L. DeRisi, V. R. Iyer and P. O. Brown. Science 278 (1997), pp. 680-686). Because the relative abundance of transcripts is often tailored to specific cellular needs, most expression profiling studies to date have focused on the genes that respond to conditions or treatments of interest.

Arrays of biomolecules, such as arrays of peptides or arrays of polynucleotides are useful for this type of analysis. Such arrays include regions (sometimes referred to as spots) of usually different sequence biomolecules arranged in a predetermined configuration on a substrate. The arrays, when exposed to a sample, will exhibit a pattern of binding or activity that is indicative of the presence and/or concentration of one or more components of the sample, such as an antigen in the case of a peptide array or a polynucleotide having a particular sequence in the case of a polynucleotide array. The binding pattern can be detected by, for example, labeling all potential targets (e.g., DNA) in the sample with a suitable label (e.g., a fluorescent compound), and observing a signal pattern (e.g., fluorescence) on the array.

Such an analysis generally involves immobilizing a biomolecule on a substrate composition in a manner that preserves the biological activity of the biomolecule. Although a variety of techniques is known to be useful for genetic analysis (e.g., analysis of DNA, RNA, and peptide nucleic acids (PNA)), techniques that are useful for analysis of other water-soluble biomolecules, particularly proteins and peptides, are still needed.

Patterned micro- or nanostructure devices have wide-ranging commercial, medical, and research uses. In a microarray, certain molecules are immobilized within discrete known regions on a substrate. The microarray is made using a method of sequentially synthesizing a probe material on a substrate or a spotting method in which a previously-synthesized probe material is immobilized on an activated substrate.

Examples of such a microarray include polynucleotide and protein microarrays. DNA microarrays (commonly referred to as gene chips) are one example of a commercially available patterned microstructure. Exemplary uses for DNA microarrays include gene expression studies and SNP (single nucleotide polymorphism) detection systems. U.S. Pat. No. 5,143,854 teaches the attachment of proteins in discrete spots as an array on a glass plate and mentions a desire to expand such from proteins to create microarrays wherein cells are immobilized. Creating microarrays of living cells on glass slides or other chips is also addressed in U.S. Pat. No. 6,548,263, which patent teaches the use of a glass wafer or the like which is first treated with an aminosilane to create a hydrophillic surface having reactive amino groups, a concept that is now well-known in this art. More specialized arrays have also been developed for use in protein analysis which have focused both upon attaching and displaying proteins as a part of a microarray and upon analyses where DNA arrays are employed for DNA/protein interactions.

Many microarray chips have been developed in the past where probes have been immobilized on a modified glass substrate, a silicon substrate, or the like, at distinct spatial locations, to create an array which presents a large number of different probes. Initially microarrays were developed as a two-dimensional form wherein probes were directly bound on the surface on the substrate. More recently three-dimensional microarrays have been developed using hydrogel materials wherein the microspots may resemble minute hemispheres, the porous structures of which present a three-dimensional framework or matrix. Microarrays of this type are described in U.S. Pat. No. 6,174,683 and in published International Application WO 02/059372. Three-dimensional (3D) microspots have been developed using hydrogels and the like in order to better bind and present proteins as part of such a microarray. WO02/059372 shows a biochip that has been made with a plurality of microspots, in the form of optically clear hydrogel cells, attached to the top surface of the chip. These polymeric hydrogel microspots can be used either to bind proteins for interactions or to bind capture agents or probes that will subsequently react with and/or sequester proteins or peptides applied thereto in solution. For example, antigens may be bound to the surface for attachment to antibodies, or vice versa.

According to the conventional technology, a linker material can react with a probe material after being coated on a substrate and activated. Thus, reaction efficiency is low and uniform activation cannot be achieved. In addition, a conventional linker material includes a hydrophobic portion such as an alkyl group. Thus, in a method in which signals generated by a reaction between a probe material and a target material on a microarray manufactured using the conventional linker material are measured and analyzed, the analysis efficiency is poor due to a strong signal generated by non-specific binding of the target material to a background portion, i.e., a strong noise.

Fabrication of patterned micro- or nano-structure devices presents a number of challenges. For example pattern resolution or fidelity, replication time, replication cost, and yield are all important factors when evaluating a fabrication technique. Fabrication techniques can be conceptual divided into two groups: serial fabrication techniques that typically produce high resolution patterns at the expense of time and/or cost, and parallel fabrication techniques that typically produce the entire desired pattern simultaneously and therefore rapidly, though commonly with a loss of resolution or pattern fidelity when compared to serial techniques. Etching and deposition are examples of serial fabrication techniques; whereas stamping and printing are examples of parallel fabrication techniques. A common method of micro- or nanostructure fabrication involves the serial fabrication of a template array, which is subsequently used to print or stamp multiple copies. Another distinction between fabrication techniques is their suitability for organic (e.g., DNA or protein) or “soft” pattern fabrication. Certain techniques may be suited only for inorganic (e.g., metals and semiconductors) or “hard” pattern fabrication.

While microarrays provide a platform for massively parallel assays for qualitative gene expression their use in clinical settings which require consistent quantitative measurements have been lacking. It has been observed that groups of genes detected as differentially expressed on a particular microarray platform are often not reproducible across microarray platforms (Shippy, R. et al. BMC Genomics 5, 61 (2004)). A source of variability is the limited and variable sensitivity of the different microarray platforms for detecting weakly expressed genes, which affect interplatform reproducibility of differentially expressed genes.

Current methods for nucleic acid synthesis uses a traditional monomer-by monomer approach. Nucleic acid probes used in oligonucleotide DNA microarrays are synthesized in this manner at high cost and the low reproducibility. Thus, there is considerable variability between microarrays fabricated in this manner that carry identical sets of probes. This hinders widespread and reliable use of microarrays in research and clinical settings. Therefore, there is a need to develop a microarray platform that is consistent and reproducible in the quality of each probe associated with the microarray.

Specific molecules can spontaneously arrange on various surfaces forming two-dimensional mono-molecular layers called self-assembled monolayers (SAMs). Patterned DNA SAMs can be used as templates for a novel printing technique for organic materials called Supramolecular NanoStamping (SuNS). Supramolecular NanoStamping (SuNS) is a newly developed stamping technique that enables the transfer of spatial together with chemical information from a template containing DNA features to a secondary substrate. (Yu A A et al. J. Mater. Chem., (2006)16, 2868-2870). This method, like the DNA/RNA information transfer, uses the reversible assembly of DNA double strands as a way of transferring patterns from a surface to another. The method relies on the biochemical ability of DNA to replicate and avoids the reproducibility problems associated with traditional monomer-by monomer chemical synthesis of nucleic acids to generate microarrays. One of the main advantages of SuNS is that multiple DNA strands each encoding different information can be printed at the same time in parallel. (Yu A A et al. Nano Lett. 2005 June;5(6):1061-1064).

Liquid supramolecular nano-stamping (LiSuNS) is a parallel fabrication technique suitable for fabricating “soft” DNA micropatterns in a hydrogel or a hydrophobic polymer. Briefly, SuNS of DNA microarrays employs the following steps: 1) provision of a template array having a patterned, single-stranded DNA monolayer; 2) immersion of the template in a solution containing DNA complementary to the DNA of the template array, the complementary DNA (cDNA) is modified with polymer-binding group; 3) addition of a prepolymer solution compatible with the polymer-binding group of the cDNA; 4) curing of the polymer solution to form a hydrogel having cDNA covalently bound in the micropattern of the template array; and 5) separation of the template array and the patterned hydrogel. Whereas solid substrate stamping techniques are limited by template-copy conformational issues when printing large patterns, LiSuNS is well-suited, relative to certain other fabrication techniques, for large printing patterns due to the high conformational properties of the liquid “substrate.”

However, like many parallel fabrication methods, LiSuNS is vulnerable to template array degradation over repeated fabrication cycles. Described herein are methods of microstructure fabrication capable of providing pattern densities in excess of the template array. In one embodiment, the methods provided herein may be used to fabricate DNA microarrays with a probe density greater than that of the patterned DNA template array used in fabrication.

### SUMMARY OF THE PREFERRED EMBODIMENTS

A feature of SuNS is the flexibility of substrate material onto which DNA molecules may be printed. A good substrate shall have properties such that it simultaneously (a) provides ideal conditions for SuNS printing, and (b) optimizes microarray assay performance. The present invention relates to the discovery that the surface of a hydrogel polymer is the ideal substrate that satisfies these criteria.

There are essentially two technical challenges to consider with any SuNS approach. The first challenge is to achieve nanometric conformal contact between two surfaces over a macroscopic area. Existing strategies include a deformable PDMS substrate with built-in drainage canals developed by Crooks et al. (Lin H et al. J Am Chem Soc. 2005 August 17;127(32):11210-1) as well as a liquid prepolymer strategy pioneered by Stellacci et. al. The second major challenge of SuNS is to minimize damage to the template DNA which may result from repeated cycles of surface-to-surface contact. While literature exists for related systems (Burnham MR et al. Biomaterials. 2006 27(35):5883-91; Mitra R D et al. Nucleic Acids Res. 1999 December 15;27(24):e34), the inventor of the present invention is the first to overcome these two challenges simultaneously of SuNS by printing onto the surface of a hydrogel. The deformability of the gel permits large-area conformal contact, while many non-destructive printing cycles are possible, due to the protective effects of the gel layer.

Described herein is a method of manufacturing a patterned hydrogel array, the method having the steps of: contacting a patterned substrate with a hydrogel substrate to form a substrate complex; the patterned substrate having: a surface; and a first polymer covalently attached to the surface, the first polymer having a sequence of polymer subunits; the hydrogel substrate having: a polymer matrix having a polymer weight-volume percentage of less than 12%, or less than or about 10%; a second polymer covalently attached to the polymer matrix at a defined position; the second polymer is capable of binding the first polymer and has a sequence of polymer subunits complementary to at least a portion of the sequence of polymer subunits of the first polymer; and subjecting the substrate complex to a polymer extension cycle.

The polymer extension cycle may comprise the steps of: binding the first polymer to the second polymer to form a dimer having a first polymer portion and second polymer portion; extending the second polymer portion of the dimer using the sequence of polymer subunits of the first polymer portion as a template; disassociating the dimer to form an extended second polymer and to re-form the first polymer; and separating the substrate complex to obtain a patterned hydrogel array having an extended second polymer attached, preferably covalently or through strong, specific non-covalent interactions such as biotin-(strep)avidin, at the defined position.

Another aspect includes a method for manufacturing a patterned hydrogel array comprising contacting a patterned substrate with a hydrogel substrate to form a substrate complex wherein the patterned substrate comprises a surface and a first polymer attached to the surface, the first polymer having a sequence of polymer subunits, wherein the hydrogel substrate comprises a polymer matrix and a second polymer attached to the polymer matrix, wherein the second polymer is capable of binding the first polymer and has a sequence of polymer subunits complementary to at least a portion of the sequence of polymer subunits of the first polymer; subjecting the substrate complex to a polymer extension cycle; the polymer extension cycle comprising binding the first polymer to the second polymer to form a dimer having a first polymer portion and second polymer portion; extending the second polymer portion of the dimer using the sequence of polymer subunits of the first polymer portion as a template; disassociating the dimer; separating the substrate complex to obtain a patterned hydrogel array having an extended second polymer attached at the defined position; and optionally repeating the contacting, subjecting and separating steps with the same patterned substrate. Yet another embodiment includes a method for manufacturing a patterned array on a substrate comprising contacting a patterned hydrogel with a substrate to form a substrate complex, wherein the patterned hydrogel comprises a polymer matrix and a first polymer attached to the polymer matrix, the first polymer having a sequence of polymer subunits, wherein the substrate comprises: a second polymer attached to the substrate wherein the second polymer is capable of binding the first polymer and has a sequence of polymer subunits complementary to at least a portion of the sequence of polymer subunits of the first polymer; subjecting the substrate complex to a polymer extension cycle; the polymer extension cycle comprising binding the first polymer to the second polymer to form a dimer having a first polymer portion and second polymer portion, extending the second polymer portion of the dimer using the sequence of polymer subunits of the first polymer portion as a template, and disassociating the dimer; separating the substrate complex to obtain a patterned array on a surface having an extended second polymer attached at the defined position; and optionally repeating contacting subjecting and separating steps with the same patterned hydrogen. Another aspect includes a method for manufacturing a patterned hydrogel array comprising contacting a first patterned hydrogel with a second hydrogel to form a hydrogel complex, wherein the first patterned hydrogel comprises a first polymer matrix and a first polymer attached to the first polymer matrix, the first polymer having a sequence of polymer subunits, wherein the second hydrogel comprises a second polymer matrix and a second polymer attached to the second polymer matrix, wherein the second polymer is capable of binding the first polymer and has a sequence of polymer subunits complementary to at least a portion of the sequence of polymer subunits of the first polymer; subjecting the hydrogel complex to a polymer extension cycle; the polymer extension cycle comprising the steps of binding the first polymer to the second polymer to form a dimer having a first polymer portion and second polymer portion, extending the second polymer portion of the dimer using the sequence of polymer subunits of the first polymer portion as a template, and disassociating the dimer; separating the hydrogel complex to obtain a second patterned hydrogel having an extended second polymer attached at the defined position; and optionally repeating the contacting subjecting and separating steps using the same first patterned hydrogel.

Yet another aspect includes a method of manufacturing a patterned hydrogel array comprising contacting a patterned substrate with a hydrogel substrate to form a substrate complex, wherein the patterned substrate comprises a surface, a first polymer attached to the surface, the first polymer having a sequence of polymer subunits, and a second polymer reversibly attached to the first polymer forming a dimer wherein the second polymer comprises at least one attachment group suitable for binding to the attachment site, and wherein the hydrogel substrate comprises: a polymer matrix and a plurality of attachment sites along the polymer matrix capable of attaching the second polymer, binding at least one attachment site to the second polymer, and disassociating the dimer; separating the substrate complex to obtain a patterned hydrogel array having a second polymer attached to an attachment site; and optionally repeating the contacting, binding and separating step using the same patterned substrate, and optionally replacing the second polymer after the separating step.

Another aspect includes a method of manufacturing a patterned array on a substrate comprising contacting a patterned hydrogel with a substrate to form a substrate complex, wherein the patterned hydrogel comprises: a hydrogel, a first polymer attached to the hydrogel, the first polymer having a sequence of polymer subunits, and a second polymer reversibly attached to the first polymer forming a dimer, wherein the substrate comprises: a surface and a plurality of attachment sites on the surface capable of attaching the second polymer, wherein the second polymer comprises at least one attachment group suitable for binding to the attachment site; binding at least one attachment site to the second polymer and disassociating the dimer; separating the substrate complex to obtain a patterned substrate array having a second polymer attached to an attachment site; and optionally repeating the contacting, binding and separating steps using the same patterned substrate, and optionally replacing the second polymer after the separating step.

Yet another aspect includes a method of manufacturing a patterned hydrogel array comprising contacting a first patterned hydrogel with a second hydrogel to form a hydrogel complex, wherein the first patterned hydrogel comprises: a hydrogel, a first polymer attached to the hydrogel, the first polymer having a sequence of polymer subunits, and a second polymer reversibly attached to the first polymer forming a dimer, wherein the second hydrogel substrate comprises: a polymer matrix and a plurality of attachment sites along the polymer matrix capable of attaching the second polymer, wherein the second polymer comprises at least one attachment group suitable for binding to the attachment site; binding at least one attachment site to the second polymer and disassociating the dimer; separating the hydrogel complex to obtain a second patterned hydrogel array having a second polymer attached to an attachment site; and optionally repeating the contacting, binding and separating steps using the same patterned substrate, and optionally replacing the second polymer after the separating step.

All of the foregoing aspects further include embodiments wherein the hydrogel complex further comprises reagents in solution for the activities selected from: binding the first polymer to the second polymer to form a dimer having a first polymer portion and second polymer portion; extending the second polymer portion of the dimer using the sequence of polymer subunits of the first polymer portion as a template; and disassociating the dimer.

All of the foregoing aspects and embodiments further include embodiments wherein the first polymer is a nucleic acid molecule selected from the group consisting of DNA, RNA, PNA, LNA and derivatives thereof.

The foregoing embodiments further include embodiments wherein the first polymer is DNA and the extending step comprises use of a DNA polymerase selected from the group consisting of E. coli DNA polymerase I (including Klenow fragment), T7 DNA polymerase, Thermus thermophilus (Tth) DNA polymerase, Bacillus stearothermophilus DNA polymerase, Thermococcus litoralis DNA polymerase, Thermus aquaticus (Taq) DNA polymerase and Pyrococcus furiosus (Pfu) DNA polymerase, Thermococcus litoralis (Vent) DNA polymerase, TOPOTAQ DNA polymerase, Phi29 DNA polymerase, 9° Nm DNA polymerase, DyNAzyme™ EXT DNA polymerase, Phusion™ Polymerase, Therminator™ Polymerase and T4 DNA Polymerase.

The foregoing embodiments further include embodiments wherein the first polymer is RNA and the extending step comprises use of a reverse transcriptase or RNA polymerase selected from the group consisting of E. coli Poly(A) polymerase, AMV reverse transcriptase, M-MuLV reverse transcriptase, phi6 RNA Polymerase (RdRP), SP6 RNA polymerase and T7 RNA polymerase.

All of the foregoing aspects and embodiments further include embodiments wherein the polymer matrix is selected from the group consisting of a polyethylene glycol matrix, a polypropylene glycol matrix, a polyacrylamide matrix, a poly(tetrahydrofuran) matrix, a poly(ethylene glycol) metacrylate matrix a poly(2-hydroxyethyl methacrilate) matrix, a polyammidoammine matrix and a polylysine matrix, or any combination thereof.

All of the foregoing aspects and embodiments further include embodiments wherein the second polymer is an oligonucleotide primer.

### DESCRIPTION OF DRAWINGS

FIG. 1A illustrates formation of a hydrogel comprising oligonucleotide primers and wetted with nucleic acid polymerase and dNTPs in solution.

FIG. 1B illustrates contacting the template array with the hydrogel comprising primer oligonucleotides.

FIG. 1C illustrates primer extension on the hydrogel replicate in contact with the template microarray.

FIG. 2 illustrates rolling circle amplification of probe DNA on the template array as more fully described in the Italian Patent application BO2007A000627 naming Andrea Cuppoletti, Francesco Stellacci and Harry B. Larman as inventors which is herein incorporated by reference.

FIG. 3 illustrates template array before and after stamping and the corresponding replica slide after stamping and after hybridization with target probe.

### DETAILED DESCRIPTION OF THE INVENTION

The following description sets forth numerous exemplary configurations, parameters, and the like. It should be recognized, however, that such description is not intended as a limitation on the scope of the present invention, but is instead provided as a description of exemplary embodiments.

### Patterned Hydrogel Array Fabrication

According to this invention, the replica printed surface comprises a hydrogel coating that allows conformal contact between the stamp and the replica, prevents damage to the template DNA, improves the efficiency of the hybridization process, and allows fast linkage of the replica DNA strands to the hydrogel coating.

The present invention takes advantage of the fact that a low percentage hydrogel has wetting properties similar to water, such that bringing this object into conformal contact with a DNA microarray will not damage it. In one embodiment, primers have been covalently incorporated into the gel matrix, so that they are mobile, but only within a distance similar to the distance between crosslinks. Once the hydrogel is in contact with the surface of the template microarray, the primers are allowed to anneal with the template strands. The hydrogel is previously or concurrently wetted with a solution containing DNA polymerase and dNTPs, the primers are then extended along the template strands. A key advantage of this approach is that thermal cycling of the system saturates all of the available primers. The resultant microarray embedded within the hydrogel can potentially contain a much higher number of probes per site as compared to the original template microarray.

Described herein are methods for fabricating a patterned hydrogel array that incorporates a polymer pattern based on the polymer pattern of a template array.

In one embodiment, the patterned hydrogel array is fabricated by contacting a hydrogel substrate with a template array, having a polymer pattern of interest.

In one embodiment, the template array is contacted with one or more extendable polymers and is subjected to a polymer extension cycle prior to contact with the hydrogel substrate.

In another embodiment, the hydrogel substrate contains one or more covalently-linked, extendable primers capable of binding to the polymers of the template array.

In an embodiment in which the template array was not subjected to a polymer extension cycle, the hydrogel substrate-template array complex is then subjected to one or more polymer extension cycles. The hydrogel substrate is separated from the template array, resulting in a patterned hydrogel array with a greater density of patterned polymers than the template array on which it is based.

Patterning polymers that may used with the methods described herein include, but are not limited to, modified or unmodified DNA molecules, modified or unmodified RNA molecules, modified or unmodified proteins, an the like.

The hydrogels for use with the present methods include, but are not limited to, polyacrylamide hydrogels, polyethylene glycol hydrogels, urethane-based polymer hydrogels, and the like.

A “hydrogel array” is a combination of two or more microlocations. In certain embodiments, an array is comprised of microlocations in addressable rows and columns. Such a hydrogel array as contemplated herein is known in the art, and referred to by a variety of names (e.g., “gel pad array”, “polyacrylamide array”, etc.). The thickness and dimensions of the polymer hydrogel and/or hydrogel arrays produced according to the invention can vary dependent upon the particular needs of the user. Optionally, however, with incorporation into a hydrogel array, the hydrogel microlocations will each have a thickness of less than about 20 microns, a thickness of between about 0.2 and about 40 microns, a thickness of between about 1 and about 30 microns, or will be about 5 microns thick. Furthermore, the hydrogel microlocations in an array are each from about 5 to about 500 microns in size, particularly from about 50 to about 400 microns, and especially from about 100 to about 200 microns.

The hydrogel used may have wetting properties similar to that of water. The low weight/volume percent hydrogel may allow for contact between the hydrogel and the template array without imposing a significant amount of damage to the patterned polymers of the template array. Desirably, the polymer hydrogel or polymer hydrogel array according to the invention is coated onto a solid support. Namely, desirably the polyacrylamide reactive prepolymer is first produced, and then is deposited on the surface of the solid support by any appropriate means.

Polymer initiation may be performed by any means suitable for the selected polymers. In certain embodiments, polymerization may be initiated using a soluble initiator. As another example, polymerization may be photoinitiated.

Polymer extension may be performed by any means suitable for the selected polymers. In one embodiment employing DNA polymers, extension may be performed through the addition of DNA polymerase and deoxyribonucleotide triphosphates. Polymerase chain reaction thermocycles are performed to extend the covalently-linked, extendable polymers of the hydrogel.

According to this invention, a “biomolecule” (i.e., a biological molecule) is any molecule that can be attached to a hydrogel (e.g., a polyacrylamide hydrogel) or solid support, using the methods of the invention. However, a biomolecule may also be selected from the group consisting of: nucleic acid such as DNA or RNA or PNA molecule (or fragment thereof), polynucleotide, or oligonucleotide, and any synthetic or partially synthetic modification of any nucleic acid; peptide, polypeptide, oligopeptide, or protein, and any modification thereof; lipids, and any modification thereof; polysaccharide, and any modification thereof; or any combination (i.e., within the same molecule) of the foregoing entities.

A “biopolymer” is a polymer of one or more types of repeating units. Biopolymers are typically found in biological systems and particularly include polysaccharides (such as carbohydrates), peptides (which term is used to include polypeptides and proteins) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides.

In certain embodiments, recognition components and their targets may include nucleic acid/complementary nucleic acid, antigen/antibody, antigen/antibody fragment, avidin/biotin, streptavidin/biotin, protein A/Ig, lectin/carbohydrate and aptamer/target. As used herein, “aptamer” refers to a non-naturally occurring nucleic acid that binds selectively to a target. The nucleic acid that forms the aptamer may be composed of naturally occurring nucleosides, modified nucleosides, naturally occurring nucleosides with hydrocarbon linkers (e.g., an alkylene) or a polyether linker (e.g., a PEG linker) inserted between one or more nucleosides, modified nucleosides with hydrocarbon or PEG linkers inserted between one or more nucleosides, or a combination of thereof. In one embodiment, nucleotides or modified nucleotides of the nucleic acid ligand can be replaced with a hydrocarbon linker or a polyether linker provided that the binding affinity and selectivity of the nucleic acid ligand is not substantially reduced by the substitution (e.g., the dissociation constant of the aptamer for the target should not be greater than about 1×10⁻⁶ M). The target molecule of a aptamer is a three dimensional chemical structure that binds to the aptamer. However, the aptamer is not simply a linear complementary sequence of a nucleic acid target but may include regions that bind via complementary Watson-Crick base pairing interrupted by other structures such as hairpin loops. Targets of aptamers include peptide, polypeptide, carbohydrate and nucleic acid molecules.

The term “nucleic acids,” or “oligonucleotides,” as used herein, refers to a polymer of nucleotides. Typically, a nucleic acid comprises at least three nucleotides. The polymer may include natural nucleosides (i.e., adenosine, thymidine, guanosine, cytidine, uridine, deoxyadenosine, deoxythymidine, deoxyguanosine, and deoxycytidine) or modified nucleosides. Examples of modified nucleotides include base modified nucleoside (e.g., aracytidine, inosine, isoguanosine, nebularine, pseudouridine, 2,6-diaminopurine, 2-aminopurine, 2-thiothymidine, 3-deaza-5-azacytidine, 2′-deoxyuridine, 3-nitorpyrrole, 4-methylindole, 4-thiouridine, 4-thiothymidine, 2-aminoadenosine, 2-thiothymidine, 2-thiouridine, 5-bromocytidine, 5-iodouridine, inosine, 6-azauridine, 6-chloropurine, 7-deazaadenosine, 7-deazaguanosine, 8-azaadenosine, 8-azidoadenosine, benzimidazole, Ml-methyladenosine, pyrrolo-pyrimidine, 2-amino-6-chloropurine, 3-methyl adenosine, 5-propynylcytidine, 5-propynyluridine, 5-bromouridine, 5 -fluorouridine, 5 -methylcytidine, 7-deazaadeno sine, 7-deazaguano sine, 8-oxoadenosine, 8-oxoguanosine, O(6)-methylguanine, and 2-thiocytidine), chemically or biologically modified bases (e.g., methylated bases), modified sugars (e.g., 2′-fluororibose, 2′-aminoribose, 2′-azidoribose, 2′-O-methylribose, L-enantiomeric nucleosides arabinose, and hexose), modified phosphate groups (e.g., phosphorothioates and 5′-N-phosphoramidite linkages), and combinations thereof. Natural and modified nucleotide monomers for the chemical synthesis of nucleic acids are commercially available.

The term “peptide nucleic acid (PNA),” as used herein, refers to a polymer that has a peptide backbone in which a natural or non-natural nucleic acid base is attached to each amino acid residue. Peptide nucleic acids are described in Hanvey, et al., Science (1992), 258:1481-1485. A PNA can bind specifically to a nucleic acid or another PNA that has a complementary sequence of at least three consecutive bases or at least six consecutive bases, to the sequence of the PNA

Biopolymers include DNA (including cDNA), RNA, oligonucleotides, and PNA and other polynucleotides as described in U.S. Pat. No. 5,948,902 and references cited therein, regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (e.g., a single amino acid or nucleotide with two linking groups one or both of which may have removable protecting groups).

Immobilization of biomolecules (e.g., DNA, RNA, peptides, and proteins, to name but a few) through chemical attachment on a solid support or within a matrix material (e.g., hydrogel, e.g., present on a solid support) has become a very important aspect of molecular biology research (e.g., including, but not limited to, DNA synthesis, DNA sequencing by hybridization, analysis of gene expression, and drug discovery) especially in the manufacturing and application of microarray or chip-based technologies. Typical procedures for attaching a biomolecule to a surface involve multiple reaction steps, often requiring chemical modification of the solid support itself, or the hydrogel present on a solid support, in order to provide a proper chemical functionality capable forming a covalent bond with the biomolecule. The efficiency of the attachment chemistry and strength of the chemical bonds formed are critical to the fabrication and ultimate performance of the microarray.

In some embodiments, a biomolecule of the invention is a nucleic acid or fragment thereof containing less than about 5000 nucleotides, especially less than about 1000 nucleotides. Desirably, a biomolecule of the invention is an oligonucleotide. A biomolecule of the invention (i.e., including a biomolecule other than a nucleic acid) optionally comprises a spacer region. Optimally, a biomolecule has been functionalized by attachment of a reactive site, as further described herein. In some cases, the biomolecule already contains a reactive site with no further modification needed (e.g., certain nucleic acid species that incorporate pyrimidines such as thymine, or are modified to contain thymine or polythymine, or proteins incorporating thiols).

Thus, according to the invention, modified DNA oligonucleotides/polynucleotides are employed which include a reactive site that is capable of undergoing photocycloaddition. Examples of other such reactive sites include, but are not limited to, dimethyl maleimide, maleimide, citraconimide, electron deficient alkenes (e.g., cyano alkene, nitro alkene, sulfonyl alkene, carbonyl alkene, and arylnitro alkene), thymine, polythymine (e.g., having 3 or more thymine residues or from about 2 to 50 thymine residues) as well as further reactive sites described below. The biomolecules then desirably are attached to the hydrogel itself. Typically the reactive site is introduced into the nucleic acid species, for instance, by synthesizing or purchasing the DNA already functionalized with amine, and then subsequently reacting this using known reactions to obtain the DNA having the reactive site, e.g., maleimide-functionalized DNA.

In some cases, it may be necessary or desirable to include within (i.e., attach to) a biomolecule, particularly a nucleic acid species of biomolecule, a spacer region between the nucleic acid and the reactive site, or between the polymer and the reactive site, to ensure an optimal distance of the biomolecule from the solid support and/or hydrogel, and to ensure the availability of the biomolecule for further manipulation/reaction. Such spacer regions are known and have been described in the art, and in some cases, may be commercially available, e.g., biotin (long arm) maleimide (Xenopure). Any spacer region can be employed, so long as the spacer region does not negate the desirable properties of the biomolecule (e.g., ability of nucleic acid species to function as either a probe or primer). In certain embodiments, spacer regions according to the invention are organic chains of about 6-50 atoms long.

### Hydrogel Labeled Primer Extension (HLPE)

When employed in the fabrication of hydrogel DNA microarrays, the methods described herein may be referred to as hydrogel labeled primer extension (HLPE). Broadly, HLPE employs the use of a DNA template array, a low percentage hydrogel substrate incorporating covalently linked oligonucleotide primers, and polymerase chain reaction (PCR) thermocycling to yield a hydrogel microarray potentially having a greater density of DNA probes, arrayed in a desired pattern, than the template array from which the hydrogel is “stamped.”

### A. Template Array Preparation

Template microarrays can be fabricated using drop deposition from pulse-jets of either polymer precursor units (for example, nucleotide monomers for a nucleic acid polymer) in the case of in situ fabrication, or a previously obtained polymer (for example, a polynucleotide). Array fabrication methods include robotic contact printing, ink-jetting, piezoelectric spotting and photolithography. A number of commercial arrayers are available [e.g. Packard Bioscience] as well as manual equipment [V & P Scientific]. Such methods are described in detail in U.S. Pat. Nos. 6,242,266, 6,232,072, 6,180,351, 6,171,797, 6,323,043 and references cited therein. Other drop deposition methods can be used for fabrication, as well as other array fabrication methods such as pin spotting and techniques described in U.S. Pat. Nos. 5,599,695, 5,753,788, and 6,329,143 and digital micromirrors as described in U.S. Pat. No. 7,037,659.

In one embodiment, the template array has a pattern of biopolymer molecules covalently attached to the array surface. Biopolymer arrays can be fabricated by depositing previously obtained biopolymers (such as from synthesis or natural sources) onto a substrate, or by in situ synthesis methods. Methods of depositing obtained biopolymers include loading then touching a pin or capillary to a surface, such as described in U.S. Pat. No. 5,807,522 or deposition by firing from a pulse jet such as an inkjet head, such as described in PCT publications WO 95/25116 and WO 98/41531. For in situ fabrication methods, multiple different reagent droplets are deposited by pulse jet or other means at a given target location in order to form the final feature which is synthesized on the array substrate). The in situ fabrication methods include those described in U.S. Pat. No. 5,449,754 for synthesizing peptide arrays, and in U.S. Pat. No. 6,180,351 and WO 98/41531 and the references cited therein for polynucleotides, and may also use pulse jets for depositing reagents.

For example, the template microarrays may be produced by a number of means, including “spotting” wherein small amounts of the reactants are dispensed to particular positions on the surface of the substrate. Methods for spotting include, but are not limited to, microfluidics printing, microstamping (see, e.g., U.S. Pat. No. 5,515,131, U.S. Pat. No. 5,731,152, Martin, B. D. et al. (1998), Langmuir 14: 3971-3975 and Haab, B B et al. (2001) Genome Biol 2 and MacBeath, G. et al. (2000) Science 289: 1760-1763), microcontact printing (see, e.g., PCT Publication WO 96/29629), inkjet head printing (Roda, A. et al. (2000) BioTechniques 28: 492-496, and Silzel, J. W. et al. (1998) Clin Chem 44: 2036-2043), microfluidic direct application (Rowe, C. A. et al. (1999) Anal Chem 71: 433-439 and Bernard, A. et al. (2001), Anal Chem 73: 8-12) and electrospray deposition (Morozov, V. N. et al. (1999) Anal Chem 71: 1415-1420 and Moerman R. et al. (2001) Anal Chem 73: 2183-2189).

The chemistry for synthesis of polynucleotides is described in Caruthers, Science 230: 281-285, 1985; Itakura et al., Ann. Rev. Biochem. 53: 323-356; Hunkapillar et al., Nature 310: 105-110,1984;; U.S. Pat. No. 4,458,066; U.S. Pat. No. 4,500,707; U.S. Pat. No. 5,153,319; U.S. Pat. No. 5,869,643; and EP 0294196. The phosphoramidite and phosphite triester approaches are most broadly used, but other approaches include the phosphodiester approach, the phosphotriester approach and the H-phosphonate approach. The substrates are typically functionalized to bond to the first deposited monomer. Suitable techniques for functionalizing substrates with such linking moieties are described, for example, in Southern, E. M., Maskos, U. and Elder, J. K., Genomics, 13, 1007-1017, 1992. In the case of array fabrication, different monomers and activator may be deposited at different addresses on the substrate during any one cycle so that the different features of the completed array will have different desired biopolymer sequences. One or more intermediate further steps may be required in each cycle, such as the conventional oxidation, capping and washing steps in the case of in situ fabrication of polynucleotide arrays (again, these steps may be performed in flooding procedure).

Further details of fabricating biopolymer arrays by depositing either previously obtained biopolymers or by the in situ method are disclosed in U.S. Pat. No. 6,242,266, U.S. Pat. No. 6,232,072, U.S. Pat. No. 6,180,351, and U.S. Pat. No. 6,171,797. In fabricating arrays by depositing previously obtained biopolymers or by the in situ method, typically each region on the substrate surface on which an array will be or has been formed (“array regions”) is completely exposed to one or more reagents. For example, in either method the array regions will often be exposed to one or more reagents to form a suitable layer on the surface that binds to both the substrate and biopolymer or biomonomer. In in situ fabrication the array regions will also typically be exposed to the oxidizing, deblocking, and optional capping reagents. Similarly, particularly in fabrication by depositing previously obtained biopolymers, it may be desirable to expose the array regions to a suitable blocking reagent to block non-specific binding to a target spot.

In one embodiment, the DNA template array has a pattern of DNA molecules covalently attached to the array surface. The pattern may be any desired pattern and the DNA molecules may be DNA polymers having any sequence. The sequences of the polymers may be heterologous or homologous. In one embodiment, the DNA polymers are polymers having a primer binding sequence common to all the polymers.

In one embodiment, the DNA template array for use with HLPE is fabricated using dip-pen nanolithography (DPN) as described in Demers et al. “Direct patterning of modified oligonucleotides on metals and insulators by dip-pen nanolithography.” Science 296, 1836-1838 (2002).

In another embodiment, the DNA template array is fabricated by creating a pattern of reactive material on a suitable substrate surface that is subsequently reacted with modified DNA. In an embodiment of this practice, electron beam lithography, as described by Ahmed, H., is used lay a pattern of gold, which is subsequently reacted with thiolated DNA molecules. “Physical Principles of Electron-Beam Lithography.” Science Progress 70, 473-487 (1986).

In another embodiment, the DNA template array is fabricated by backfilling or blocking lithography: partially blocking a reactive surface using a pattern of nonreactive molecules followed by treatment with modified DNA. In an embodiment of this practice, a gold substrate is partially blocked with a octadecane thiol pattern applied using microcontact printing (tCP), as described by Quist et al., followed by reaction with thiolated DNA molecules. “Recent advances in microcontact printing.” Analytical and Bioanalytical Chemistry 381, 591-600 (2005).

A number of ways to generate peptide template arrays are known, a few of which are represented below. All of them can be adapted for use in the instant invention.

WO 03/038033A2 describes the use of ultrahigh resolution patterning carried out by dip-pen nanolithographic printing, for constructing peptide and protein nanoarrays with nanometer-level dimensions. This application demonstrates how dip pen nanolithographic printing can be used in methods to generate high density protein and peptide patterns, which exhibit bioactivity and virtually no non-specific adsorption. The method is suitable for a wide range of protein and peptide structures including peptides and antibodies. Features at or below 300 nm can be achieved using this method.

U.S. 20020037359A1 relates to arrays of peptidic molecules and the preparation of peptide arrays using focused acoustic energy. The arrays are prepared by acoustically ejecting peptide-containing fluid droplets from individual reservoirs towards designated sites on a substrate for attachment thereto.

A large number of diverse arrays of polypeptides and polymers is synthesized in U.S. Pat. No. 5,143,854 to Pirrung et al. (1992). This patent describes the use of photo lithographic techniques for the solid phase synthesis of arrays of polypeptides and polymers. The disclosed technique uses “photomasks” and photo-labile protecting groups for protecting the underlying functional group.

In WO 93/22480, Southern describes a method for synthesizing polymers at selected sites by electrochemically modifying a surface. In each step, an array of electrodes is mechanically placed adjacent the points of synthesis, and a voltage is applied that is sufficient to produce electrochemical reagents at the electrode. The electrochemical reagents are deposited on the surface themselves or are allowed to react with another species, found either in the electrolyte or on the surface, in order to deposit or modify a substance at the desired points of synthesis.

Detailed methods for preparing the template array is disclosed in DNA Microarrays Part A: Array Platforms & Wet-Bench Protocols, Volume 410 (Methods in Enzymology (2006); Academic Press, San Diego, Calif.).

A major factor in obtaining high quality and reproducible arrays is to control spatial selectivity in the deposition or fabrication of DNA strands, onto the substrate. In one embodiment, probe solvent is physically confined in micro-wells during the probe-immobilization phase of template fabrication. The confinement not only achieves spatial selectivity, but also allows for a more uniform and consistent spot quality. Traditional spotted microarrays suffer from features of very low uniformity. Because solvent volume ejected from a pin or an ink-jet inevitably varies to some degree, so does the diameter of the resultant spot. Feature morphology is further perturbed during the drying process, often resulting in artifacts such as “coffee rings”. Assay results are often obscured by the inability of analysis software to distinguish between artifact and information. To attain the required resolution, microwells are generated by photolithography, either directly onto the surface or on a separate mask applied onto to the substrate. Optimized coating , photolithography and spotting methodologies are extended to multiple sequences, where an unique strand is deposited in each well comprising a primer sequences common to every other strand and a probe sequence which is unique for that position on the array.

In some embodiments the array on the template is itself amplified prior to replicating on the hydrogel. In some embodiments, thermocycling methods of DNA amplification such as polymerase chain reaction (PCR) or ligase chain reaction (LCR) using thermostable enzymes. In other embodiments, isothermal methods of DNA amplification are used including but not limited to Strand Displacement Amplification (SDA), Bridge Amplification, Helicase Dependent Amplification (HDA), Loop-Mediated Isothermal Amplification (LAMP) and Rolling Circle DNA Amplification (RCA). In L-RCA (ligation-rolling circle amplification) thermostable ligation of circularizable padlock-like DNA probes for allelic SNP discrimination with subsequent RCA procedure for signal enhancement is carried out. In some embodiments, peptide nucleic acid (PNA) oligomers can be employed as site-specific openers of the DNA double helix to locally expose a designated marker sequence inside duplex DNA. Recently, rolling-circle amplification (RCA) with Phi29 DNA polymerase has been applied in vitro to marker DNA sequences (using specific primers) and to circular cloning vectors (using random hexamer primers) to achieve their exponential amplification via DNA strand displacement. (DNA Amplification: Current Technologies and Applications, Vadim V. Demidov and Natalia E. Broude eds. (2004) Horizon Scientific Press, UK). The foregoing techniques are more fully described in the Italian Patent application B02007A000627 naming Andrea Cuppoletti, Francesco Stellacci and Harry B. Larman as inventors which is herein incorporated by reference.

### B. Hydrogel Preparation

Hydrogels are a class of polymer materials that can absorb large amounts of water without dissolving. The latter is due to physical or chemical crosslinkage of the hydrophilic polymer chains. Hydrogels can be prepared starting from monomers, prepolymers or existing hydrophilic polymers. The present invention generally relates to hydrogels and blends which are generally known in the polymer art. See, for example, (1) Contemporary Polymer Chemistry, Allcock and Lamp, Prentice Hall, 1981, and (2) Textbook of Polymer Science, 3rd Ed., Billmeyer, Wiley-Interscience, 1984.

In the present invention, polymer blends can be prepared by mixing two or more polymers together including binary and ternary blends. Blends can be formulated in the present invention to provide high quality thin layers. The polymers can be in a variety of forms including, for example, homopolymers, copolymers, crosslinked polymers, network polymers, short chain or long chain branched polymers, interpenetrating polymer networks, and other types of mixed systems known in the polymer art. The polymer blends can swell when exposed to aqueous environments and form hydrogel states characterized by pore size and high water content.

Copolymerisation of hydrophilic monomers and polyfunctional comonomers, acting as crosslinkers, leads to the formation of hydrophilic network structures. Most commonly used monomers are hydrophilic (meth)acrylates and (meth)acrylamides (Schacht E 1987 Int. Pharm. J. 1:3). One of the first examples reported in the literature (Wichterle 0 and Lím D 1960 Nature 185 117-8) was a copolymer of (2-hydroxyethyl) methacrylate (HEMA) and ethyleneglycol bismethacrylate (EGDMA). The resulting hydrogel has been used for the production of soft contact lenses and as reservoir for drug delivery. Crosslinked copolymers of acrylamide and methylene bisacrylamide are daily used to prepare gels for electrophoresis. Polymerization of vinyl monomers is most frequently initiated via radical initiators (peroxides, azo-compounds). Radicals are generated by heating, by the use of a redox initiator (e.g. ammonium persulfate+N,N′-tetramethyl ethylenediamine, TEMED) or a photoinitiator. An alternative way to initiate the radical polymerisation process is by high energy irradiation. Polyethylene glycol may be generated by polymerization of ethylene oxide by reaction of the ethylene oxide monomers with water, ethylene glycol or ethylene glycol oligomers. The polymerization reaction may be catalyzed by acidic or basic catalysts.

Hydrogels have been prepared by crosslinkage of low molecular weight hydrophilic prepolymers or oligomers. One example is the reaction of α,ω-hydroxyl poly(ethylene glycol) with a diisocyanate in the presence of a triol as crosslinker (Van Bos M, Schacht E 1987 Acta Pharm. Technol. 33(3):120; Graham N B 1987 Hydrogels in Medicine and Pharmacy vol. 2 ed Peppas N A (CRC Press, Boca Raton) chapter 4). This reaction leads to the formation of crosslinked hydrophilic polyurethanes. An alternative approach is the conversion of the hydroxyl end groups of poly(ethylene glycol) into (meth)acrylate which can then be crosslinked via radical polymerisation.

Other polymers like gelatin and agarose can form hydrogels upon cooling from an aqueous solution. The gel formation is due to helix-formation and association of the helices, forming junction zones. These physically crosslinked hydrogels have a sol-gel transition temperature. Permanent crosslinkage can be achieved by subsequent chemical crosslinkage. Gelatin chemically modified with methacrylamide side groups can subsequently be polymerized by radical initiators or high energy irradiation. (Van den Bulcke A, Bogdanov B, De Rooze N and Schacht E 2000 Biomacromol. :31)

A hydrogel according to this invention comprises a long-chain, hydrophilic polymer containing amine-reactive groups. This polymer is covalently crosslinked to itself and placed on a support surface such as a slide. In some embodiments, the hydrogel is covalently attached to the surface of the support. On a standard 2-D planar surface, hybridization efficiency is affected by steric hindrance. To overcome this, longer oligonucleotide probes are often necessary. However, longer probes can compromise discrimination and specificity during hybridization. The three-dimensional nature and water-like physical properties of a hydrogel allows all bases of the probes participate in hybridization and the hybridization kinetics are very similar to those observed in solution-phase hybridization.

In some embodiments, the crosslinked polymer, combined with end-point attachment, orients the immobilized DNA, and holds it away from the surface of the support. This combination makes the DNA more readily available for hybridization and may eliminate the need for poly(dT) or PEG spacers on oligonucleotides. Additionally, the hydrophilic nature of the polymer provides a passivating effect once the DNA has been immobilized resulting in lower background.

Hydrogels have garnered considerable interest as the chemical constituent of microstructures for biological applications. A hydrogel is a three-dimensional polymer, or array of polymers, that is hydrated by water or an aqueous solution. Tanaka, “Gels,” Sci. Am., 244, 124-138 (1981). Typical polymers that comprise hydrogels include proteins and/or sugars. Protein- or sugar-based hydrogels may exhibit properties that resemble those of various biological materials including extracellular matrices, particularly when the protein or sugar is a naturally occurring biological macromolecule. U.S. Pat. No. 6,174,683 discloses a method of rapidly and inexpensively producing a biochip using a polyurethane-based hydrogel in order to immobilize a probe material on a substrate.

The use of enzymes, antibodies, peptides, or other bioactive molecules, e.g. aptamers, has received increasing attention in creating tools for screening in the fields of bioassays and proteomics, and the use of 3-dimensional hydrogel supports for these bioactive materials in microarrays has recently gained in importance. Hydrogels are water-containing polymeric matrices. In particular, hydrogels provide a support for biomaterials that more closely resembles the native aqueous cellular environment, as opposed to a more denaturing environment that results when nucleic acids, proteins or other such materials are directly attached to a solid support surface using some other molecular scale linkages.

Polyacrylamide hydrogels are especially employed as molecular sieves for the separation of nucleic acids, proteins, and other moieties, and as binding layers to adhere to surfaces biological molecules including, but not limited to, proteins, peptides, oligonucleotides, polynucleotides, and larger nucleic acid fragments. In the fabrication of polyacrylamide hydrogel arrays (i.e., patterned gels) used as binding layers for biological molecules, the acrylamide solution typically is imaged through a mask during the UV polymerization/crosslinking step. In an application of lithographic techniques known in the semiconductor industry, light can be applied to discrete locations on the surface of a polyacrylamide hydrogel to activate these specified regions for the attachment of an anti-ligand, such as an antibody or antigen, hormone or hormone receptor, oligonucleotide, or polysaccharide on the surface of a polyacrylamide hydrogel on a solid support (WO 91/07087). Following fabrication of the hydrogel array, the polyacrylamide subsequently is modified to include functional groups for the attachment of moieties, and the moieties (e.g., DNA) later are attached.

Another type of substrate composition that has been used is a polyurethane gel. A polyurethane gel is created from a polyurethane network and a solvent. The polyurethane network envelopes the solvent and can prevent the solvent from flowing out of the network. The properties of a polyurethane gel depend largely on the structure of the polyurethane network that makes up the gel and the interaction of the network and the solvent. The polyurethane network depends on the crosslink structure of the network, which depends on, for example, the amount and type of the reactants used to make the network and their ability to react to near completion. The polyurethane network can be important for determining the strength of the gel and can also be important for the diffusion of molecules through the gel.

U.S. application 2003/0124371 discloses the use of water-swellable hydrophilic hydrogels which are considered to be particularly useful for immobilizing polypeptide analytes onto an absorbent layer, which is engineered by varying the ratio of hydrophilic moieties and hydrophobic moieties in the hydrogel. The hydrophilic and hydrophobic monomers which make up the hydrogel are cross-linked to create a desired polymer. For example, an aluminum substrate is coated with silicon dioxide and then treated with an alkylsilane before the monomers are applied to a plurality of addressable locations (microspots) and then cross-linked by radiation. Probes are added to each microspot on the chip, using a binding buffer, and the loaded chip is incubated for thirty minutes. Washing then readies the chip for use in an assay.

U.S. application 2003/0138649 teaches the fabrication of microarrays suitable for attaching proteins which will serve as probes or capture agents using a gelatin-based substrate. A suitable substrate such as glass or silicon or photographic paper is coated with a solution of type IV gelatin; for example, gelatins were coated onto reflective photographic paper and then chill-set and dried. The plates having the overall gelatin coating are then microspotted to attach bi-functional compounds, e.g. goat anti-mouse antibody IgG, which has a group that will link to the gelatin and a second functional group that is capable of interacting with high specificity with a protein. In U.S. application, No. 2003/0170474, a silicon wafer or glass plate is treated first with an alkylsilane and then dipped in a solution of gelatin. The gelatin-coated substrate is then dipped in a solution of polyethyleneimine (PEI). The surface was reported to have a relatively low nonspecific binding capacity for proteins and that it could be used as a microarray substrate by affixing protein capture agents at microspots spaced across the surface.

U.S. application 2006/0040274 discloses microarrays that can be fabricated by providing a substrate, the upper surface of which is functionalized with organic molecules, and coating that surface with a polymerizable hydrogel layer which contains anchoring moieties disbursed uniformly throughout so as to cover a continuous region of the surface that will serve as a microarray. After curing the coated substrate so as to polymerize the coated hydrogel layer, a variety of different probes are attached at distinct spatial locations on the surface to form microspots, by linking the probes to the anchoring moieties that are present in the cured hydrogel layer.

Microarrays where three-dimensional microspots of hydrogels are employed to serve as holders for the probes or capture agents are described in U.S. Pat. No. 6,174,683 and in published international applications WO 09/059,372, entitled “Three Dimensional Format Biochips”, and WO 02/081662, entitled “Methods and Gel Compositions For Encapsulating Living Cells and Organic Molecules”.

The hydrogel substrate used in HLPE is prepared as a prepolymer mix poured into a gel tray or other suitable support material. The support material used in the form of a flat plate or the like may be selected from, but is not limited to, glass, quartz, silicon, silica, metal, ceramic, stainless steel and inert polymers, such as polyethylenes, polypropylenes, polyacrylics, polycarbonates and the like, as well known in the art.

The prepolymer used may be any suitable prepolymer including, but not limited to, acrylamide; polydimethylsiloxane; urethane-based prepolymer; polyethylene glycol that is end-capped with toluene diisocyanate; a copolymer of ethylene oxide and propylene oxide (optionally with trimethylolpropane) and toluene diisocyanate; toluene diisocyanate-polyethylene glycol-trimethylopropane, methylene diisocyanate-methylene homopolymer; polymeric methylene diisocyanate-polyethylene glycol; polymer of ethylene oxide-propylene oxide-trimethylolpropane and isophorone diisocyanate, and polyethylene glycol trilactate and toluene diisocyanate. Suitable prepolymers of the above types are available from Dow Chemical Company as HYPOL PreMA® G-50, HYPOL® 2000, HYPOL® 3000, HYPOL® 4000 and HYPOL® 5000, which formulations generally include copolymers of polyethylene oxide and a minor amount of polypropylene oxide. Others are available under the trademark Urepol from EnviroChem Technologies, and comparable prepolymers can be prepared from commercially available feedstocks. The main chain of the hydrogel polymer can be comprised of polyethylene glycol, polypropylene glycol, or a copolymer of polyethylene glycol and polypropylene glycol. Non-ionic, hydrophilic properties of polyethylene glycol and polypropylene glycol hydrogels provide for low levels of non-specific binding of analyte to the hydrogel and also provide good compatibility with biomolecules that may be immobilized therewith so as to maintain native conformation and bioreactivity thereof. Polyurethane-based isocyanate-functional hydrogels of this general type are described in U.S. Pat. No. 3,939,123 (Mathews, et al.), U.S. Pat. No. 4,110,286 (Vandegaer, et al.) and U.S. Pat. No. 4,098,645 (Hartdegan, et al.).

The polymerizable hydrogel can be made using isocyanate-functional prepolymers that are prepared from relatively high molecular weight polyoxyalkylene diols or polyols by reacting them with difunctional and/or polyfunctional isocyanate compounds. In some embodiments, prepolymers are ones made from polyoxyalkylene diols or polyols that comprise homopolymers of ethylene oxide units or block or random copolymers containing mixtures of ethylene oxide units and propylene oxide or butylene oxide units. Suitable prepolymers may be prepared by reacting selected polyoxyalkylene diols or polyols with a polyisocyanate so that essentially all of the hydroxyl groups are capped with polyisocyanate. Generally, polyethylene glycol (PEG), polypropylene glycol (PPG) or copolymers thereof are preferred. If relatively low molecular weight prepolymers, e.g. less than 2,000 daltons, are used, they preferably contain a relatively high isocyanate content (about 1 meq/g or even higher). However, the polymerization rate of such smaller prepolymers may require more precise control to avoid too rapid polymerization. Thus, higher molecular weight prepolymers which contain a relatively low isocyanate content may be preferred.

When acrylamide prepolymers are utilized, the hydrogels may contain acrylamide-functionalized carbohydrate, sulfoxide, sulfide or sulfone copolymerized with hydrophilic or hydrophobic copolymerizing material, such as acrylamide, methacrylamide, acrylate, methacrylate or vinyl or their derivatives such as 2-hydroxyethyl methacrylate.

In one embodiment, the prepolymer mix used is an acrylamide mix poured into a glass gel tray. Preferably, the prepolymer is provided in a concentration so as to yield a low percentage hydrogel. In some embodiments, the prepolymer is acrylamide, having a weight per volume (w/v) percentage selected from 15%, 10%, 5%, 4%, 3%, 2%, and 1% w/v.

In some embodiments, the hydrogel contains anchoring moieties dispersed uniformly throughout, which moieties are used to either directly or indirectly anchor the probes as part of a microarray. They may be dissolved in aqueous solution and mixed with a prepolymer to begin the polymerization reaction. Examples of suitable anchoring moieties include organic chelators and organic linkers, which may be one-half of a pair of complementary linkers, such as streptavidin and biotin, the other member of which pair is then attached to the probe of interest.

Besides prepolymer, the mix may also include at least modified oligonucleotide primers. Modification can be made with any group capable of covalently linking to the polymer to be formed by the selected prepolymer.

The preparation of oligonucleotide conjugates is often accomplished through the use an oligonucleotide modified with a primary amine (Agrawal, S. (1994) Functionalization of oligonucleotides with amino groups and attachment of amino specific reporter groups. Methods in Molecular Biology 26; Protocols for Oligonucleotide Conjugates. (S. Agarwal, Ed.) pp. 73-92, Humana Press, Totowa, N.J. (Review), Meyers, R. (1994) Incorporation of Modified Bases into Oligonucleotides. Methods in Molecular Biology 26; Protocols for Oligonucleotide Conjugates. (S. Agarwal, Ed.) pp. 93-120, Humana Press, Totowa, N.J. (Review)). In most cases, amide or thiourea bonds are formed with conjugars containing an activated carboxyl or isothiocynate (ITC) functionality.

Although functionalization of many conjugars is routine, a number of conjugars have proved to be very difficult to transform into activated carboxyl or ITC derivatives either because of the complex synthesis involved or the inherent instability of the final compound. In an effort to circumvent these difficulties the coupling partners have been reversed placing the carboxylic acid function on the oligonucelotide, and the amine on the conjugar. The literature contains several examples of 5′ terminal oligonucleotide linkers that contain a carboxyl functionality. Kremsky et al. ((1987) Immobilization of DNA via oligonucleotides containing and aldehyde or carboxylic acid group at the 5′ terminus. Nucleic Acids Research 15, 2891-2909), describe conjugation with a protected 5′ terminal oligonucleotide carboxyl group requiring cleavage of the methyl ester protecting group, followed by in situ activation with N-hydroxysuccinimide (“NHS”) and a coupling reagent to achieve conjugation.

In another approach, the protecting group is a benzyl ester, which can be directly coupled to an amine (Endo, M., Gaga, Y., and Komiyama, M., (1994) A novel phosphoramidite for the site-selective introduction of functional groups into oligonucleotides via versatile tethers. Tetrahedron Letter 33, 3879-3882). U.S. Pat. No. 5,663,242 describes 5′ end-attachment of oligonucleotides to polyacrylamide solid supports via a thioether linkage. A thiol-derivatized oligonucleotide is reacted with a reactive carbon center-derivatized polyacrylamide support (e.g., bromoacetyl-derivatized polyacrylamide support), or conversely, a reactive carbon center-derivatized oligonucleotide (e.g., a bromoacetyl-oligonucleotide) is reacted with thiol-derivatized polyacrylamide support to produce a polyacrylamide support with 5′-end attached oligonucleotides.

Another approach describes the formation of a phosphoramidate bond between a 3′ or 5′ phosphorylated oligonucleotide and an amino acid, followed by subsequent activation of the carboxyl moiety with carbodiimide (Gottikh, M., Asseline, U., and Thoung, N. T. (1990) Synthesis of oligonucleotides containing a carboxyl group at either their 5′ end or their 3′ end and their subsequent derivatization by an intercalating agent. Tetrahedron Letters 31, 6657-6660).

A recent method has employed direct co-polymerization of an acrylamide-derivatized oligonucleotide. For instance, ACRYDITE® (Mosaic Technologies, Boston, Mass.) is an acrylamide phosphoramidite that contains an ethylene group capable of free radical polymerization with acrylamide. Acrydite-modified oligonucleotides are mixed with acrylamide solutions and polymerized directly into the gel matrix (Rehman et al., Nucleic Acids Research, 27, 649-655 (1999). This method relies on acrylamide as the monomer. Depending on the choice of chemical functionality, similar problems in the stability of attachment, as with the above-mentioned methods, also result. In one embodiment, the primers are Acrydite® modified oligonucleotide primers and the prepolymer is acrylamide. Concentration of primers may be selected to control the desired probe density of the final patterned hydrogel, as detailed below.

Published US patent application no. 20030096265 describes a method of incorporating [2+2] photoreactive sites into oligonucleotides using photoreactive phosphoramidites. Using this method hydrogel can be formed by polymerizing acrylamide in a controlled fashion to obtain a “prepolymer.” The prepolymer may then be coated on a solid support, such as a glass microscope slide and photochemically crosslinked. Using [2+2] cycloaddition chemistry, photoreactive oligonucleotide primers, including DNA, RNA, and modifications thereof, can be attached to the hydrogel.

The prepared prepolymer mix is cured, using the method appropriate to the selected prepolymer, to form the hydrogel substrate for use in HLPE. In an embodiment having acrylamide as the prepolymer, curing can be performed chemically through the addition of tetramethylethylenediamine (TEMED) and ammonium persulfate or can be performed by exposure to ultraviolet light. The resulting hydrogel may have wetting properties similar to that of water. At least a portion of the modified oligonucleotide primers are covalently incorporated into the hydrogel matrix. In one embodiment, the modified primers are mobile in the cured hydrogel, but only within a distance proportional to the length of the crosslinking group. A wash is performed to remove any unincorporated primer. The cured hydrogel is subsequently wetted with a solution containing at least polymerase, deoxyribonucleotide triphosphates (dNTP: i.e., dATP, dCTP, dGTP, and dTTP), and buffer, in preparation for contact with the template array.

Biological materials that are employed as capture agents or probes can be any of a wide variety well known in this art. They may run the gamut from DNA sequences and peptides through much larger molecules, such as antibodies; even living cells may be attached at distinct spatial locations to the porous hydrogel using appropriate complementary linkers. Many other such binding pairs in addition to the chelators and biotin-avidin are well known in the art.

The invention also provides a hydrogel polymer blend composition comprising: (a) a first polymer comprising a photocrosslinked functionality, and (b) a second polymer comprising (i) one or more functionalities for selectively binding a biomolecular analyte by non-covalent binding, (ii) one or more functionalities for selectively binding a biomolecular analyte by covalent binding, or combinations thereof. In certain embodiments, the second polymer comprises (i) one or more functionalities for selectively binding a biomolecular analyte by non-covalent binding. In another embodiment, the second polymer comprises (ii) one or more functionalities for selectively binding a biomolecular analyte by covalent binding. Polymers that may be used as substrates include, but are not limited to: polyalkyleneamine (PAI); polyethyleneimine (PEI); polyacrylamide; polyimide; and various block co-polymers. Also provided is a hydrogel coating kit comprising: (a) a first composition comprising a first polymer comprising a photocrosslinkable functionality, wherein the first polymer optionally also comprises functionality for selectively binding a biomolecular analyte, and (b) a second composition comprising a second polymer comprising (i) functionality for selectively binding a biomolecular analyte, wherein the functionality for selective binding a biomolecular analyte in the first polymer and the second polymer can be the same or different,

Although the characteristics of the support may vary depending upon the intended use, the shape, material and surface modification of the substrates must be considered. Although the substrate may have at least one surface which is substantially planar or flat, it may also include indentations, protuberances, steps, ridges, terraces and the like and may have any geometric form (e.g., cylindrical, conical, spherical, concave surface, convex surface, string, or a combination of any of these). Suitable support materials include, but are not limited to, glasses, ceramics, plastics, metals, alloys, carbon, papers, agarose, silica, quartz, cellulose, polyacrylamide, polyamide, and gelatin, as well as other polymer supports, other solid-material supports, or flexible membrane supports. An embodiment of the support is a plain 2.5 cm×7.5 cm glass slide with surface Si—OH functionalities.

In some embodiments, it may be found useful to select a support material having UV, IR, or visible light transmission properties, for use with light-based detection technologies. The plate may be optionally coated with a reflective layer, as also well known in this art. The reflective layer may cover substantially all of the surface region of the substrate where the probes will be attached, i.e. the array region; however, often a reflective coating that covers the entire upper surface of the substrate is used for manufacturing convenience. The reflective layer may be a reflective metal, e.g., aluminum, silver, gold, rhodium etc., which provides a mirrored layer. By reflective metal is meant a metal that reflects at least 90% of incident light in the wavelength region of interest, generally visible (400-800 nm), and possibly including longer wavelengths in the near infrared, such as 800-1100 nm, with very little (at or near 0%) light being refracted into the medium. Such a thin metal layer may be provided using any of the conventional vapor coating or other coating methods well known in the art for providing such mirror coatings. The thickness of the layer is not of particular consequence so long as there is continuity, but a layer about 0.01 micron to about 15 microns thick is generally used when such a layer is included. C. Replica Hydrogel Arrays

In the method of the invention, a template array, that includes a substrate having a first set of molecules bound to at least one surface in a pattern, is used to induce the assembly of a second set of molecules via reversible supra-molecular chemistry (e.g., hydrogen bonds, ionic bonds, covalent bonds, van der Waals bonds, or a combination thereof). The second set of molecules are immobilized on the crosslinked polymer strands of a hydrogel. Optionally, this is followed by a step where the second molecule is allowed to polymerize using the first molecule as a template, such as in a primer extension along a template strand with nucleic acid molecules. Then, the reversible bonds between the first set of molecules and the second set of molecules are broken and the hydrogel bearing a replica of the template array is removed.

The bonds formed between the first set of molecules and the second set of molecules may be hydrogen bonds, ionic bonds, covalent bonds, van der Waals bonds, or a combination thereof. The bonds formed between the first set of molecules and the second set of molecules may be hydrogen bonds. In one embodiment, the bonds between the first set of molecules and the second set of molecules are broken by applying heat. In another embodiment, the bonds between the first set of molecules and the second set of molecules are broken by contacting the bonds with a solution having a high ionic strength. In yet another embodiment, the bonds between the first set of molecules and the second set of molecules are broken by contacting the bonds with a solution having a high ionic strength and applying heat. In still another embodiment, the bonds between the first set of molecules and the second set of molecules are broken by application of mechanical forces. Alternatively, the bonds between the first set of molecules and the second set of molecules are broken by contacting them with a solution containing an enzyme that breaks the bonds. Typically, the bonds between the first set of molecules and the second set of molecules can be broken without breaking most of the bonds between the second set of molecules and the second hydrogel substrate.

In one embodiment, the first set of molecules includes two or more different molecules that have recognition components that are different nucleic acid sequences. In this embodiment, the second set of molecules includes molecules that have a nucleic acid sequence, or a portion thereof, that is complementary to at least one of the molecules of the first set of molecules. In one embodiment, hydrogen bonds between hybridized molecules from the first set of molecules and the second set of molecules are broken by contacting the hydrogen bonds with an enzyme. For example, an enzyme from the helicase family of enzymes may be use to break the bonds between hybridized nucleic acid molecules. Various helicases have been reported to dehybridize double stranded oligonucleotides. For example, E. coli Rep, E. coli DnaB, E. coli UvrD (also known as Helicase II), E. coli RecBCD, E. coli RecQ, bacteriophage T7 DNA helicase, human RECQL series; WRN(RECQ2), BLM(RECQL3), RECQL4, RECQL5, S. Pombe rqhl, C. elegance T04A11.6 (typically, the helicase name is derived from the organism from which enzymes comes). Cofactors which stabilize single stranded DNA, such as single stranded DNA binding protein (SSB), could be added. Another method of breaking the bonds between two hybridized nucleic acids would be to use a restriction endonuclease, which recognizes specific base sequence and cleaves both strands at a specific location in the nucleic acid sequence.

Alternatively, the bonds between the first set of molecules and the second set of molecules are broken by applying heat, by contacting the bonds with a solution having a high ionic strength, or by contacting the bonds with a solution having a high ionic strength and applying heat.

The hydrogel for nucleic acid-based microarrays contains a plurality of oligonucleotide primers attached to the crosslinked polymers of the hydrogel. The primers comprise sequences complementary to sequences of nucleic acids attached to the template. The hydrogel is wetted with a suitable buffer solution for primer extension. The solution contains reagents such as dNTPs and enzymes like DNA polymerases necessary for primer extension. In some embodiments the DNA polymerase is suitable for thermal cycling. The wetted hydrogel is then contacted with the patterned, DNA template array. In some embodiments the contact is mediated by a mechanical printing device to ensure reproducibility. In some embodiments, reagents for primer extension can be supplied to the hydrogel following contact with the template.

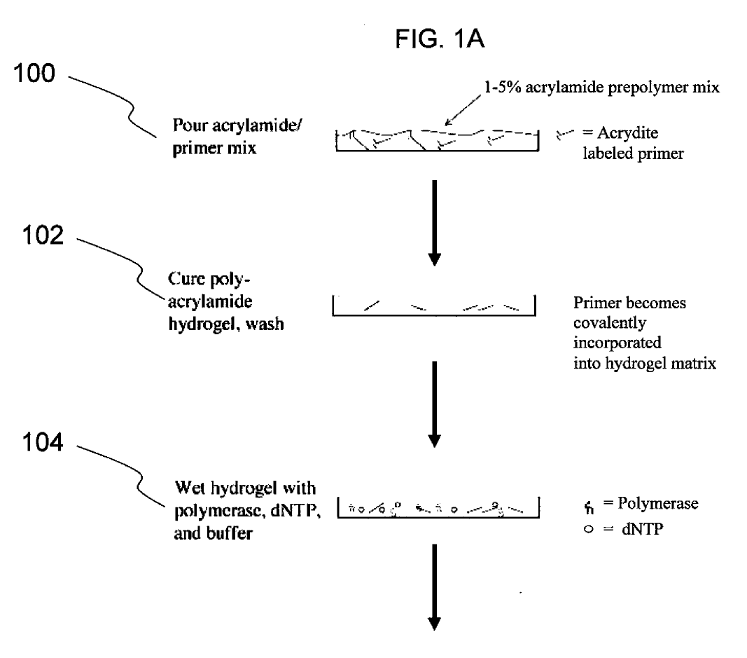

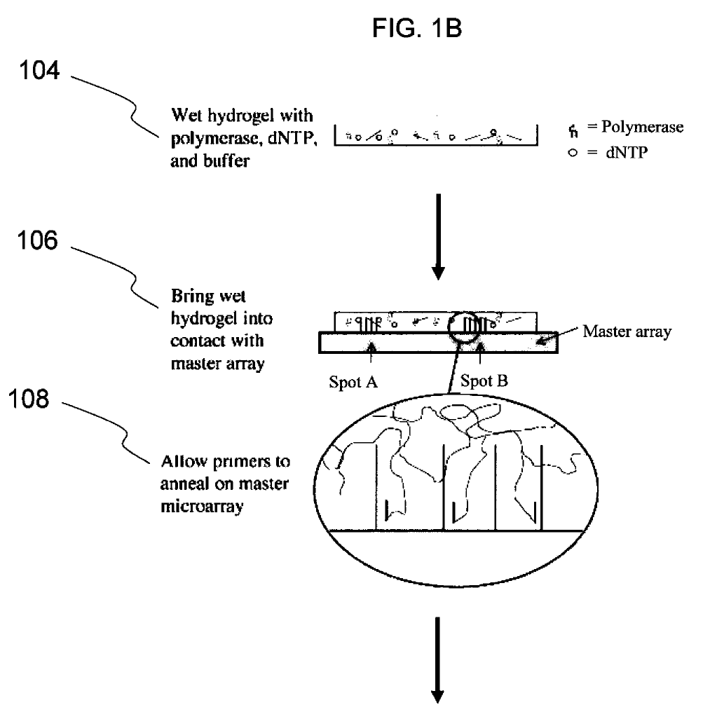

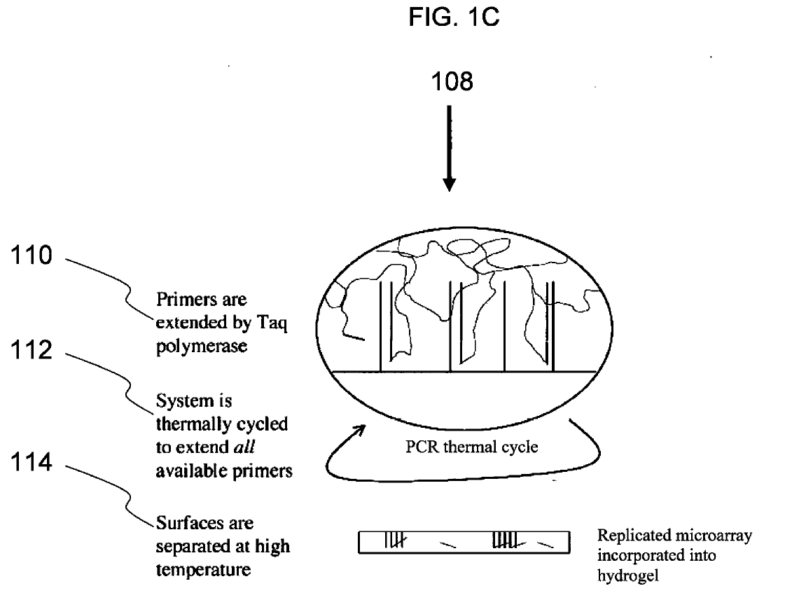

Once the hydrogel is in contact with the surface of the template microarray, the primers are allowed to anneal with the template strands. The hydrogel is wetted with solution containing nucleic acid polymerase and dNTPs, allowing the primers to extended along the template strands as shown in FIG. 1C. As used herein, “nucleic acid polymerase” refers to an enzyme that catalyzes the polymerization of nucleoside triphosphates. Generally, the enzyme will initiate synthesis at the 3′-end of the primer annealed to the target sequence, and will proceed in the 5′-direction along the template until synthesis terminates. Known DNA polymerases include, for example, E. coli DNA polymerase I, T7 DNA polymerase, Thermus thermophilus (Tth) DNA polymerase, Bacillus stearothermophilus DNA polymerase, Thermococcus litoralis DNA polymerase, Thermus aquaticus (Taq) DNA polymerase and Pyrococcus furiosus (Pfu) DNA polymerase, Thermococcus litoralis (Vent) DNA polymerase and Phi29 DNA polymerase. Chimeric DNA polymerases with thermostability, processivity and resistance to PCR inhibitors may be used. The protein chimeras contain polymerase domains fused with helix-hairpin-helix (HhH) domains derived from topoisomerase V of M. kandleri (TOPOTAQ DNA polymerases). The advantages of the chimeric DNA polymerases allow for cycle sequencing and PCR in high salt concentrations and at temperatures inaccessible for other DNA polymerases.

The template array-hydrogel complex is subjected to one or more PCR thermocycles to extend the incorporated primers. Each thermocycles comprises at least one or more of the following steps: 1) a denaturing step, 2) an annealing step, and 3) an extension step. In one embodiment, the PCR thermocycling substantial follows the steps detailed in Saiki, R. K., D. H. Gelfand, S. Stoffel, S. J. Scharf, R. Higuchi, G. T. Horn, K. B. Mullis, and H. A. Erlich. 1988. Primer-directed enzymatic amplification of DNA with a thermostable DNA polymerase. Science 239:487-491. It is understood that variations and modifications of PCR known in the art, may be employed with the methods described herein. PCR thermocycles are repeated so as to extend 50%, 60%, 70%, 80%, 90%, 95%, 99%, or 100% of the primers incorporated into the hydrogel, or so as to extend 50%, 60%, 70%, 80%, 90%, 95%, 99%, or 100% of the primers incorporated into the hydrogel that are accessible for extension. Sufficient thermocycles may be carried out to extend all or nearly all of the incorporated primers. Upon completion of the PCR thermocycling, the hydrogel, now having the microarray pattern of the template, is separated from the template array. Preferably, separation is performed at a temperature at least equal to the denaturing temperature of the DNA molecules employed.

The resulting hydrogel microarray may have a greater density of DNA probes, arrayed in the desired pattern, that the template array, depending on the concentration of primers employed and the number of PCR thermocycles.

Modifications and adaptations of the HLPE methods described herein, may be more fully understood with reference to the examples provided below.

### EXAMPLES

### Example 1

Hydrogel Primer Extension with Thermocycling

FIG. 1A-1C depict an exemplary process and system for replicating hydrogel DNA microarrays via thermal cycling. It should be recognized that the exemplary process may be adapted for the synthesis of other types of microarrays.

With reference to FIG. 1A, in step 100, a prepolymer mix containing from 1-5% (w/v) acrylamide and selected, Acrydite® modified (i.e., labeled) oligonucleotide primers is poured into a gel tray. In step 102, the prepolymer mix is chemically cured using TEMED and ammonium persulfate to form a polyacrylamide hydrogel. The hydrogel so formed, being a low percentage hydrogel, has wetting properties similar that of water. A substantial percentage of the Acrydite® modified primers become covalently incorporated into the hydrogel matrix and are spatially localized in the hydrogel, due to the covalent incorporation. Further in step 102, a wash is performed to remove any unincorporated primer. In step 104, the cured hydrogel is wetted with a solution containing buffer, DNA polymerase (e.g., Taq polymerase), and dNTP.

With reference to FIG. 1B, in step 106, the wetted hydrogel is brought into contact with a DNA template array, having a desired pattern of linked DNA polymers (probes) on its surface. The template array may be one prepared by any method known in the art. In one embodiment, the template array is prepared by first forming a pattern of reactive material (e.g., gold) on a substrate using a standard lithography technique, such as electron beam lithography followed by immersion in a solution of thiolated DNA molecules. Preferably, the oligonucleotide primers of step 100 were selected based on their ability to hybridize with the linked DNA polymers of the template array. Due to the low percentage of hydrogel, conformal contact between the wetted hydrogel and the DNA template array can be made without damage to the pattern on the template array. In step 108, a portion of the modified primers covalently incorporated into the hydrogel are allowed to anneal (i.e., hybridize) with the DNA of the template array, typically, at a temperature of 50-64° C. during an annealing step.

With reference to FIG. 1C, in step 110, the annealed primers are extended by the polymerase of the wetted hydrogel, typically at a temperature of 70-74° C. during an extension step. In step 112, PCR thermocycling is performed to extend all or substantially all of the available primers incorporated into the hydrogel. In one embodiment, the PCR thermocycling involves the sequential steps of denaturing, annealing, and extension. In an embodiment, the denaturing step typically involves a temperature of 94-96° C., held for 1-9 minutes to ensure denaturing of the template array DNA and the extended primers. In step 114, the hydrogel, now having the desired DNA microarray pattern imbedded in its surface, is separated from template array. Due to the thermal cycling, the hydrogel of this method may potentially have a greater number of DNA probes (polymers) than present in the template array. Accordingly, the disclosed method is inherently insensitive to accumulating damage on the template array (e.g., loss of linked DNA polymers on the template array surface). In one embodiment, the number of thermocycles performed are increased with extended use of a given template array, to ensure saturation of all DNA primers in the wetted hydrogels.

### Example 2

Hydrogel with Incorporated Avidin-Biotin Coupling Moieties

An exemplary process and system for replicating hydrogel DNA microarrays using avidin-biotin coupling moieties may be adapted for the synthesis of other types of microarrays.

A DNA template array, having a desired pattern of linked DNA polymers (probes) on its surface, is immersed in a suitable buffer solution containing Taq polymerase, dNTPs, and biotin-labeled oligonucleotide primers, capable of annealing to the DNA polymers of the template array. The template array may be one prepared by any method known in the art. In one embodiment, the template array is prepared according to the method detailed in Example 1, above. An annealing step typically performed at 50-64° C., is carried out to anneal at least a portion of the biotin-labeled oligonucleotide primers to a portion of the DNA polymers of the template array. Subsequently, an extension step, typically performed at 70-74° C., is carried out to extend the annealed biotin-labeled oligonucleotide primers and yields a template array having annealed, biotin-labeled DNA polymers. A prepolymer mix containing from 1-5% (w/v) acrylamide and streptavidin-acrylamide molecules is then spread over a microscope slide.

The prepolymer mix is chemically cured using TEMED and ammonium persulfate to form a polyacrylamide hydrogel. A substantial percentage of the streptavidin-acrylamide molecules become covalently incorporated into the hydrogel matrix and are spatially localized in the hydrogel, due to the covalent incorporation. Further, a wash is performed to remove any unincorporated streptavidin molecules. The cured hydrogel is brought into contact with the template array. The streptavidin molecules incorporated into the hydrogel are allowed to bind the biotin-labeled DNA polymers annealed to the template array DNA polymers. A denaturation step, typically performed at temperature sufficient to release the DNA without denaturing the streptavidin for ˜1-9 minutes, is performed to ensure denaturing of the template array DNA and the biotin-labeled DNA polymers. The hydrogel, now having the desired DNA microarray pattern imbedded in its surface, is separated from template array. It is understood that any convenient coupling moiety may be employed in the place of, or in conjunction with, the streptavidin-biotin coupling described herein.

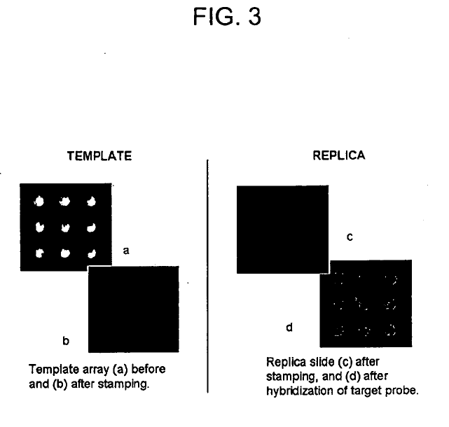

FIG. 3 illustrates a template microarray (a) before and (b) after stamping. FIG. 3 also illustrates a replica array (c) after stamping and (d) after subsequent hybridization with a target. High signal to noise ratio illustrated in FIG. 3 demonstrates that the replica arrays contain a high density of immobilized probe which is available for hybridization. Dark grey corresponds to the red signal of unbound immobilized probe while the light grey corresponds to the green signal of the immobilized probe after the target probe has hybridized.

### Example 3

Hydrogel Microarray with Biotin-Avidin-Biotin Association

The method of Example 2, above, may be modified to employ a biotin-avidin-biotin “sandwich” approach. An exemplary process and system for replicating hydrogel DNA microarrays uses biotin-avidin-biotin coupling moieties. It should be recognized that the exemplary process may be adapted for the synthesis of other types of microarrays.

A DNA template array, having a desired pattern of linked DNA polymers (probes) on its surface, is immersed in a suitable buffer solution containing Taq polymerase, dNTPs, and biotin-labeled oligonucleotide primers, capable of annealing to the DNA polymers of the template array. The template array may be one prepared by any method known in the art. In one embodiment, the template array is prepared according to the method detailed in Example 1, above. Annealing step, typically performed at 50-64° C., is carried out to anneal at least a portion of the biotin-labeled oligonucleotide primers to a portion of the DNA polymers of the template array. Subsequently, an extension step, typically performed at 70-74° C., is carried out to extend the annealed biotin-labeled oligonucleotide primers and yields a template array having annealed, biotin-labeled DNA polymers. In a deviation from Example 2, the template array having annealed, biotin-labeled DNA polymers is washed with a soluble avidin solution to produce avidin-biotin-labeled DNA polymer complexes on the template array.

A prepolymer mix containing from 1-5% (w/v) acrylamide and Acrydite® modified biotin molecules is poured into a gel tray. The prepolymer mix is chemically cured using TEMED and ammonium persulfate to form a polyacrylamide hydrogel. A substantial percentage of the Acrydite® modified biotin molecules become covalently incorporated into the hydrogel matrix and are spatially localized in the hydrogel, due to the covalent incorporation. Further, a wash is performed to remove any unincorporated biotin molecules. The cured hydrogel is brought into contact with the template array. The biotin molecules incorporated into the hydrogel are allowed to bind the avidin-biotin-labeled DNA polymers annealed to the template array DNA polymers so as to form biotin-avidin-biotin complexes which link the DNA polymers to the hydrogel. A denaturing step, typically performed at temperature sufficient to release the DNA without denaturing the streptavidin for ˜1-9 minutes, is performed to ensure denaturing of the template array DNA and the biotin-labeled DNA polymers. The hydrogel, now having the desired DNA microarray pattern imbedded in its surface, is separated from template array. It is understood that any convenient coupling moiety may be employed in the place of, or in conjunction with, the biotin-avidin-biotin coupling described herein.

### Example 4

Rolling Circle Amplification of Template array

Signal-to-noise and assay sensitivity, key features of microarray utility, are both determined by probe density within a feature. The higher the target-capture capacity of the feature per unit area, the better is the performance of the microarray. There is a fundamental limit to the oligonucleotide density which can be achieved on a surface, due to the radii of gyration of the DNA strands. Further, if probe density is too high, then the associated charges will exclude target DNA and therefore prevent hybridization.

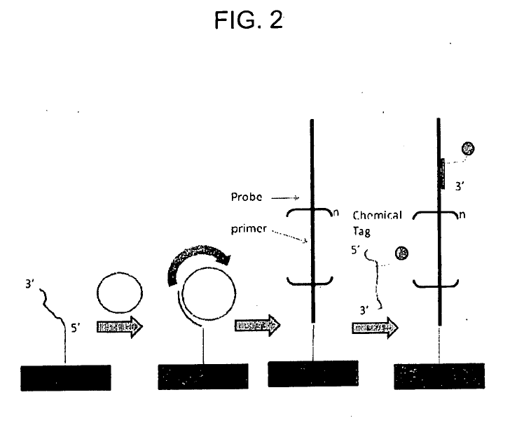

Probe density is increased by concatamerizing oligonucleotides in the direction away from the template array surface. Under certain conditions strand “hyperbranching” can be achieved to further increase the amount of DNA probe to be generated on the replica surface. (Nallur G, at al. Nucleic Acids Res. 2001 December 1;29(23):E118) Once template DNA microarray is prepared by any method described in this application the DNA strands in the template array may be amplified by Rolling Circle Amplification (RCA). The use of DNA polymerase for microarray production has several advantages. The high fidelity obtained in the synthesis process provide for high quality and reproducibility in the production process. The RCA step amplifies linearly the density of the probes, generating a strand which is a linear repeat of the probe sequence itself, as illustrated in FIG. 2. Such a high linear density of the probes increases signal to noise and assay sensitivity as multiple regions of each strand on the template array become available for hybridization to the primer strands on the replica hydrogel array. The techniques used in this Example 4 are more fully described in the Italian Patent application B02007A000627 naming Andrea Cuppoletti, Francesco Stellacci and Harry B. Larman as inventors, which is herein incorporated by reference.

### Example 5

### Methods for Detecting Binding Events on the Hydrogel Replica Array

In a usual assay, the replica microarray is exposed to a solution, usually aqueous, containing a sample of biological material under hybridization/binding conditions; the solution contains potential targets which have been tagged or labeled, either with a reporter or signal material or with a linker that will subsequently sequester a reporter material, and incubated. Label or tag is used to refer to a substituent that can be attached to a target, e.g., a nucleic acid sequence, which enables its detection and/or quantitation.

In one embodiment, the capture agent or any secondary agent that can specifically bind the capture agent may be labeled with a detectable label, and the amount of bound label can then be directly measured. The term “label” is used herein in a broad sense to refer to agents that are capable of providing a detectable signal, either directly or through interaction with one or more additional members of a signal producing system. Labels that are directly detectable and may find use in the present invention include, for example, fluorescent labels such as fluorescein, rhodamine, BODIPY, cyanine dyes (e.g. from Amersham Pharmacia), Alexa dyes (e.g. from Molecular Probes, Inc.), fluorescent dye phosphoramidites, beads, chemilumninescent compounds, colloidal particles, and the like. Suitable fluorescent dyes are known in the art, including fluoresceinisothiocyanate (FITC); rhodamine and rhodamine derivatives; Texas Red; phycoerythrin; allophycocyanin; 6-carboxyfluorescein (6-FAM); 2′,7′-dimethoxy-41,51-dichloro carboxyfluorescein (JOE); 6-carboxy-X-rhodamine (ROX); 6-carboxy-21,41,71,4,7-hexachlorofluorescein (HEX); 5-carboxyfluorescein (5-FAM); N,N,N1,N′-tetramethyl carboxyrhodamine (TAMRA); sulfonated rhodamine; Cy3; Cy5, etc. Radioactive isotopes, such as ³⁵S, ³²P, ³H, ¹²⁵I, etc., and the like can also be used for labeling. In addition, labels may also include near-infrared dyes (Wang et al., Anal. Chem., 72:5907-5917 (2000), upconverting phosphors (Hampl et al., Anal. Biochem., 288:176-187 (2001), DNA dendrimers (Stears et al., Physiol. Genomics 3: 93-99 (2000), quantum dots (Bruchez et al., Science 281:2013-2016 (1998), latex beads (Okana et al., Anal. Biochem. 202:120-125 (1992), selenium particles (Stimpson et al., Proc. Natl. Acad. Sci. 92:6379-6383 (1995), and europium nanoparticles (Harma et al., Clin. Chem. 47:561-568 (2001). The label is one that preferably does not provide a variable signal, but instead provides a constant and reproducible signal over a given period of time. the employment of substrates having such a continuous slab of hydrogel can substantially increase the efficiency with which a microarray can be fabricated using the anchoring moieties uniformly dispersed throughout.

Although the invention has been described with reference to preferred embodiments and examples thereof, the scope of the present invention is not limited only to those described embodiments. As will be apparent to persons skilled in the art, modifications and adaptations to the above-described invention can be made without departing from the spirit and scope of the invention, which is defined and circumscribed by the appended claims. The foregoing is offered primarily for purposes of illustration. It will be readily apparent to those of ordinary skill in the art that the operating conditions, materials, procedural steps and other parameters of the invention described herein may be further modified or substituted in various ways without departing from the spirit and scope of the invention. Thus, the preceding description of the invention should not be viewed as limiting but as merely exemplary.

We claim:

1. A method for manufacturing a patterned array, the method comprising the steps of:
a) providing a template that comprises a first set of molecules bound to a first substrate to form a pattern, wherein each molecule in said first set of molecules comprises:
a recognition component; and
a portion that is specific to the molecule and its position in the pattern;
b) assembling a second set of molecules on said first set of molecules, said second set of molecules comprising:
a spacer fragment;
a first reactive functional group; and
a target that is attracted to or binds to the recognition component of said first set of molecules of said first substrate;
c) providing a replica comprising a second substrate comprising a second set of reactive functional groups which can selectively bind to said first reactive functional groups of said second set of molecules;
d) contacting said first reactive functional group of said second set of molecules with said second substrate containing said second set of reactive groups;
e) optionally separating said first set of molecules from said second set of molecules;
f) optionally repeating steps (b) through (e) one or more times;
whereby said pattern is transformed onto said replica second substrate; and wherein said template, said replica or a combination thereof comprising a soft layer such that said soft layer may deform to conform with said template and/or said replica surface.

2. The method of claim 1, wherein after the assembling step (step b) and/or after the contacting step (step e), said second set of molecules is elongated so that the elongated portion of the molecules specifically binds said portion of said first set of molecules.

3. The method of claim 1, wherein said separating step (step e) comprises breaking bonds or overcoming attractive forces between said first set of molecules and said second set of molecules.

4. The method of claim 1, wherein said contacting step (step d) yields a pattern on said replica that is complementary to said pattern on said template.

5. The method of claim 1, whereby in said providing a template step (step a) or in said providing a replica substrate (step d) or a combination thereof, said soft layer comprises a polymeric material.

6. A method according to claim 5 whereby in said providing a template step (step a) or in said providing a replica substrate (step d) or a combination thereof said polymeric material comprises a hydrogel matrix.

7. The method according to claim 6, whereby in said providing a template step (step a) or in
said providing a replica substrate (step d) or a combination thereof, said hydrogel matrix
is selected from the group consisting of an agarose matrix, a polyethylene glycol matrix,
a polypropylene glycol matrix, a polyacrylamide matrix, a poly(tetrahydrofuran) matrix,
a poly(ethylene glycol) methacrylate matrix a poly(2-hydroxyethyl methacrylate) matrix,
a polyammidoammine matrix and a polylysine matrix, or any combination thereof.

8. The method of claim 7, wherein said hydrogel matrix comprises polyacrylamide matrix.

9. The method of claim 5, wherein said polymeric material comprises polymer brushes, a multilayer, branched polymers, dendrimers di- or tri-block copolymers, thin organic films, porous organic materials, inorganic polymers or a combination thereof.

10. The method of claim 9, whereby in said providing a template step (step a) or in said providing a replica substrate (step d) or a combination thereof, said soft layer comprises a surface functionalized by branched polymers.

11. The method of claim 1, whereby in said providing a template step (step a) or in said providing a replica substrate (step d) or a combination thereof, said soft layer comprises a reactive monolayer.

12. A method according to any of claim 1 whereby in said providing a template step (step a), said first set of molecules consists of nucleic acid molecules selected from the group consisting of DNA, RNA, PNA, LNA and derivatives thereof.

13. The method of claim 12, wherein said nucleic acid molecule comprises DNA.

14. The method of claim 12, wherein said nucleic acid molecule comprises RNA

15. A method according to claim 2, whereby in said providing a template step (step a), said first set of molecules consists of DNA and said elongation step of the second set of molecules comprises use of a DNA polymerase selected from the group consisting of, E. coli DNA polymerase I (including Klenow fragment), T7 DNA polymerase, Thermus thermophilus (Tth) DNA polymerase, Bacillus stearothermophilus DNA polymerase, Thermococcus litoralis DNA polymerase, Thermus aquaticus (Taq) DNA polymerase and Pyrococcus furiosus (Pfu) DNA polymerase, Thermococcus litoralis (Vent) DNA polymerase, TOPOTAQ DNA polymerase, Phi29 DNA polymerase, 9° Nm DNA polymerase, DyNAzyme™ EXT DNA polymerase, Phusion™ Polymerase, Therminator™ Polymerase and T4 DNA Polymerase.

16. The method of claim 15, wherein said DNA polymerase comprises E. coli DNA polymerase I. I (including Klenow fragment), T7 DNA polymerase, Thermus aquaticus (Taq) DNA polymerase, Thermococcus litoralis (Vent) DNA polymerase, Phi29 DNA polymerase, and T4 DNA Polymerase.

17. A method according to claim 2, whereby in said providing a template step (step a), said first set of molecules consists of RNA and said elongation step of said second set of molecules comprises use of a reverse transcriptase or RNA polymerase selected from the group consisting of for example, but not limited to, E. coli Poly(A) polymerase, AMV reverse transcriptase, M-MuLV reverse transcriptase, phi6 RNA Polymerase (RdRP), SP6 RNA polymerase and T7 RNA polymerase.

18. A method according to claim 1, whereby in said assembling a second set of molecules step (step b), said second set of molecules consists of oligonucleotide primers.

19. A method according to claim 1, whereby in said assembling a second set of molecules step (step b), said second set of molecules is linked via a linking agent to said second set of reactive functional groups on said replica surface.

20. A method according to claim 1, whereby in said providing a template step (step a), said first set of molecules is linked via a linking agent to an attachment site on said template substrate surface.

21. A method according to any of claim 2 wherein said elongation of said second set of molecules comprises a polymerase chain reaction thermocycle.

22. A method according to claim 1, wherein said patterned array is a microarray.

23. A method according to claim 22, wherein said microarray is a DNA microarray.

24. A method according to claim 5 wherein the weight-volume percentage of said polymeric material is less than 20%.

25. A method according to claim 1 whereby in said providing a template step (step a), said first set of molecules is attached to said surface by a method comprising:
immobilizing a first template molecule to the surface; and
amplifying the first template molecule to form the first set of molecules.

26. The method of claim 25, whereby in said providing a template step (step a), said first set of molecules consists of nucleic acid molecules selected from the group consisting of, for example, but not limited to DNA, RNA, PNA, LNA and derivatives thereof.

27. The method of claim 25, wherein said amplification is carried out by a process selected from PCR thermal cycling, LCR thermal cycling, Strand Displacement Amplification (SDA), Helicase Dependent Amplification (HDA), Loop-Mediated Isothermal Amplification (LAMP) or Rolling Circle DNA Amplification (RCA).

28. The method of claim 27, wherein said process comprises rolling circle amplification (RCA).

29. The method of claim 25, whereby in said providing a template step (step a), said first set of molecules consists of RNA and said amplifying step comprises use of a reverse transcriptase or RNA polymerase selected from the group consisting of for example, but not limited to, E. coli Poly(A) polymerase, AMV reverse transcriptase, M-MuLV reverse transcriptase, phi6 RNA Polymerase (RdRP), SP6 RNA polymerase and T7 RNA polymerase.

30. A method according to claim 1 whereby in said providing a template step (step a), said first set of molecules and said second set of molecules are selected from the group consisting of nucleic acid and complementary nucleic acid, antigen and antibody, antigen and antibody fragment, avidin and biotin, streptavidin and biotin, protein A and Ig, lectin and carbohydrate, phage and protein, homo- or hetero-dimerizing proteins, protein complexes, and aptamer and target.

31. A patterned array comprising a replica substrate comprising a second set of reactive functional groups bound to a first reactive functional groups of a set of molecules, wherein said replica comprising a deformable soft layer, prepared by the method of claim 1.

32. The array of claim 31, wherein said set of molecules is elongated.

33. A method according to claim 1, whereby in said providing a template step (step a), and/or in said assembling a second set of molecules step (step b), the binding of said first set of molecules to the template substrate and/or said second set of molecules to the replica substrate is mediated by a biotin-avidin or biotin-streptavidin interaction.

34. A method according to claim 1, whereby in said providing a template step (step a) said recognition component is the same for all the molecules within said first set of molecules.

35. A method according to claim 1, whereby in said providing a template step (step a) said recognition component differ within said first set of molecules in a programmed fashion.

36. A method according to claim 1, whereby in said providing a template step (step a) said recognition component differ within said first set of molecules in a random fashion.

37. A method for performing an assay, said method comprising:
Providing the patterned array comprising a replica substrate comprising a second set of reactive functional groups bound to a first reactive functional groups of a set of molecules, wherein said replica comprising a deformable soft layer.
Exposing said patterned array to an analyte.
Detecting interaction between said analyte and said patterned array.

38. The method of claim 37, wherein said assay is a molecular biology assay.

39. The method of claim 37, wherein said assay is an environmental contaminant assay.

40. The method of claim 37, wherein said assay is a metal or metal ion assay.

41. The method of claim 37, wherein said assay is an explosives or explosive precursors assay.
